(19) United States
(12) Patent Application Publication
(10) Pub. No.: US 2026/0228997 A1
(43) Pub. Date: Aug. 6, 2026

(54) BEHIND OLED AUTHENTICATION

(71) Applicant: TRINAMIX GMBH, Ludwigshafen am Rhein (DE)

(72) Inventors: Christian LENNARTZ, Ludwigshafen am Rhein (DE); Nils BERNER, Ludwigshafen am Rhein (DE)

(21) Appl. No.: 19/152,962

(22) PCT Filed: Feb. 14, 2024
(86) PCT No.: PCT/EP2024/053681

§ 371 Date: Aug. 1, 2025

(30) Foreign Application Priority Data
Feb. 15, 2023 (EP) 23156858.5

(51) Int. Cl. G06V 10/145; G06F 21/32; G06V 10/147; G06V 40/16

(52) U.S. Cl. CPC G06V 10/145; G06F 21/32; G06V 10/147; G06V 40/172

(57) ABSTRACT

Disclosed herein is an optoelectronic apparatus including at least one pattern illumination source configured for emitting at least one infrared light pattern including a plurality of infrared light spots, at least one flood illumination source configured for emitting infrared flood light, at least one image generation unit configured for generating at least one pattern image while the pattern illumination source is emitting the infrared light pattern and configured for generating at least one flood image while the flood illumination source is emitting infrared flood light. Also disclosed herein are a use of an optoelectronic apparatus, a method for authenticating a user of a device, a computer program, a computer-readable storage medium, and a non-transient computer-readable medium. Also disclosed herein are an approach of making a rearrangement of the position of the camera and an improved operation of active techniques of authentication using devices behind a display.

### FIELD OF THE INVENTION

The invention relates to an optoelectronic apparatus, use of the optoelectronic apparatus, a device for authenticating a user, a method for authenticating a user of a device. The present invention further relates to a computer program, a computer-readable storage medium and a non-transient computer-readable medium. The devices, methods and uses according to the present invention specifically may be employed for example in various areas of daily life, security technology, gaming, traffic technology, production technology, photography such as digital photography or video photography for arts, documentation or technical purposes, safety technology, information technology, agriculture, crop protection, maintenance, cosmetics, medical technology or in the sciences. However, other applications are also possible.

### Prior Art

Available authentication systems in mobile devices such as in smartphones, tablets and the like, include cameras. Said mobile devices usually have a front display such as an organic light-emitting diode (OLED) area. For the integration of a camera, a cutout of the display at the position of the camera is required. These cutouts decrease an available display area, the so-called notch, and thus, the display area available to the user. Usually, because a notch is an unpleasant feature to the user, the camera is restricted to the outer most position possible to avoid dark areas for example in the middle of the display.

Thus, currently available mobile device have the drawback that the display area is decreased due to a camera and the position of the camera cannot be adapted in order to improve process efficiency. There is desire to rearrange the position of a camera while increasing the user experience.

Moreover, in order to further improve security of biometric authentication methods, such as facial recognition, passive image processing methods used for this purpose are being supplemented with active methods. This can allow improved detection of forged authentication attempts. Active method may use laser based projection technologies for enriching scenes with additional information. For such an approach, generally an unaffected optical path for the camera (Rx) and the laser projector (Tx) would be required. For example, established active methods such as structured light, active stereo, or time of flight use light typically passing through a maximally transparent protective glass to reconstruct the three-dimensional structure of the illuminated scene from the captured images. For example, a CMOS camera sensitive in the near infrared spectral range and a laser projector emitting light in the near infrared spectral range may be used, e.g. for ensuring invisibility of the method for the user. As outlined above, in case of using a smartphone, e.g. in order to perform a secure biometric unlocking of the smartphone, such a setup requires additional cutouts in the display, e.g. in order to be used together with a selfie camera, which may work in the visible spectral range.

The laser projector may be configured for operating behind the semitransparent OLED display. This may allow reducing the number and size of cutouts within the display. The semitransparent OLED-display, typically, comprises an OLED-pixel-structure. The OLED-pixel structure may be in particular defined by the optical non-transparent cathode. The use of transparent conductive tracks and design of the drive electronics can enable (semi-) transparent areas between the OLED pixels. Whereas for the passive operation, e.g. of the selfie camera, suitable transparency can be ensured, light from the laser projector undergoes diffraction loss. Thus, active methods may have an effective transmission from 3% to 20%, only. Such diffraction loss occurs for the light emission (Tx) as well as for the light detection (Rx). In addition, the diffraction loss can be visible as artefacts, e.g. decrease of contrast, in the recorded images.

Thus, known method and devices face the following drawbacks: the resulting light at the light detection is significantly decreased due to double passage through the display; a remaining image quality may be further reduced by diffraction artifacts; the usable laser power, which would be necessary for compensating such losses, is limited due to requirements of eye safety (maximum dose after emission from the display) and display stability (maximum thermal dose).

### Problem Addressed by the Invention

It is therefore an object of the present invention to provide devices and methods facing the above-mentioned technical challenges of known devices and methods. Specifically, it is an object of the present invention to provide devices and methods, which allow rearrangement of the position of the camera as well as improved operation of active techniques of authentication using devices behind a display.

### SUMMARY OF THE INVENTION

This problem is solved by the invention with the features of the independent patent claims. Advantageous developments of the invention, which can be realized individually or in combination, are presented in the dependent claims and/or in the following specification and detailed embodiments.

In a first aspect of the present invention, an optoelectronic apparatus is disclosed. The optoelectronic apparatus comprises:
at least one pattern illumination source configured for emitting at least one infrared light pattern comprising a plurality of infrared light spots, wherein the number of infrared light spots is below or equal 4000 spots,
at least one flood illumination source configured for emitting infrared flood light,
at least one image generation unit configured for generating at least one pattern image while the pattern illumination source is emitting infrared light pattern and configured for generating at least one flood image while the flood illumination source is emitting infrared flood light.

The term “optoelectronic apparatus” as used herein is a broad term and is to be given its ordinary and customary meaning to a person of ordinary skill in the art and is not to be limited to a special or customized meaning. The term specifically may refer, without limitation, to a device or system operating on light and electrical currents.

The term “light” as used herein is a broad term and is to be given its ordinary and customary meaning to a person of ordinary skill in the art and is not to be limited to a special or customized meaning. The term specifically may refer, without limitation, to electromagnetic radiation in one or more of the infrared, the visible and the ultraviolet spectral range. Herein, the term “ultraviolet spectral range”, generally, refers to electromagnetic radiation having a wavelength of 1 nm to 380 nm, preferably of 100 nm to 380 nm. Further, in partial accordance with standard ISO-21348 in a valid version at the date of this document, the term “visible spectral range”, generally, refers to a spectral range of 380 nm to 760 nm. The term “infrared spectral range” (IR) generally refers to electromagnetic radiation of 760 nm to 1000 μm, wherein the range of 760 nm to 1.5 μm is usually denominated as “near infrared spectral range” (NIR) while the range from 1.5 μ to 15 μm is denoted as “mid infrared spectral range” (MidIR) and the range from 15 μm to 1000 μm as “far infrared spectral range” (FIR). Preferably, light used for the typical purposes of the present invention is light in the infrared (IR) spectral range, more preferred, in the near infrared (NIR) and/or the mid infrared spectral range (MidIR), especially the light having a wavelength of 1 μm to 5 μm, preferably of 1 μm to 3 μm.

The term “illuminate”, as used herein, is a broad term and is to be given its ordinary and customary meaning to a person of ordinary skill in the art and is not to be limited to a special or customized meaning. The term specifically may refer, without limitation, to the process of exposing at least one element to light. The term “illumination source” as used herein is a broad term and is to be given its ordinary and customary meaning to a person of ordinary skill in the art and is not to be limited to a special or customized meaning. The term specifically may refer, without limitation, to an arbitrary device configured for generating or providing light in the sense of the above-mentioned definition.

The term “pattern illumination source” as used herein is a broad term and is to be given its ordinary and customary meaning to a person of ordinary skill in the art and is not to be limited to a special or customized meaning. The term specifically may refer, without limitation, to an arbitrary device configured for generating or providing at least one light pattern, in particular at least one infrared light pattern. The term “light pattern” as used herein is a broad term and is to be given its ordinary and customary meaning to a person of ordinary skill in the art and is not to be limited to a special or customized meaning. The term specifically may refer, without limitation, to at least one arbitrary pattern comprising a plurality of light spots. The light spot may be at least partially spatially extended. At least one spot or any spot may have an arbitrary shape. In some cases a circular shape of at least one spot or any spot may be preferred. The spots may be arranged by considering a structure of a display comprised by a device that is further comprising the optoelectronic apparatus. Typically, an arrangement of an OLED-pixel-structure of the display may be considered. The term “infrared light pattern” as used herein is a broad term and is to be given its ordinary and customary meaning to a person of ordinary skill in the art and is not to be limited to a special or customized meaning. The term specifically may refer, without limitation, to a light pattern comprising spots in the infrared spectral range. The infrared light pattern may be a near infrared light pattern.

The infrared light may be coherent. The infrared light pattern may be a coherent infrared light pattern.

The pattern illumination source may be configured for emitting light at a single wavelength, e.g. in the near infrared region. In other embodiments, the pattern illumination source may be adapted to emit light with a plurality of wavelengths, e.g. for allowing additional measurements in other wavelengths channels.

The infrared light pattern may comprise at least one regular and/or constant and/or periodic pattern such as a triangular pattern, a rectangular pattern, a hexagonal pattern or a pattern comprising further convex tilings. The terms “triangular”, “rectangular” and “hexagonal” as used herein is a broad term and is to be given its ordinary and customary meaning to a person of ordinary skill in the art and is not to be limited to a special or customized meaning. The term specifically may refer, without limitation, to a two-dimensional distribution of spots, in particular unit cells of the pattern. The unit cell in a triangular pattern is a triangle. A triangular pattern may comprise a plurality of groups of spots, wherein each group comprises at least three spots forming a triangle. In a rectangular pattern, the spots of rows and columns are rectangular to each other, e.g. square unit cells, rectangular unit cells or centered rectangular unit cells. A hexagonal pattern comprises a plurality of groups of spots, wherein each group has at least four spots forming a hexagonal unit cell, e.g. wherein three hexagonal cells form a hexagonal prism. In a hexagonal pattern an angle of 120° is formed between neighboring spots of rows and columns. Different packing density or fraction are thinkable for the pattern, e.g. for the hexagonal pattern, e.g. a ⅖ packing density. For example, the infrared light pattern is a hexagonal pattern, preferably a hexagonal infrared light pattern, preferably a ⅖ hexagonal infrared light pattern. Using a periodical ⅖ hexagonal pattern can allow distinguishing between artefacts and usable signal.

The infrared light pattern may comprise at least one point pattern. The infrared light pattern has a low point density. The number of infrared light spots is below or equal 4000 spots. The infrared light pattern may comprise equal to or less than 3000 spots, preferably equal to or less than 2000 spots. The number of spots may be below 2000 and/or above 0, preferably above 5, more preferably above 10, most preferably above 100. The infrared light pattern may have a low point density, in particular in comparison with other structured light techniques having typically a point density of 10 k-3 0k in a field of view of 55×38°. Using such a low point density may allow compensating for the above-mentioned diffraction loss. By decreasing the number of spots projected onto an object and/or a user, a contrast in the pattern image may be increased.

Increasing the number of points would decrease the irradiance per point. The decreased number of spots may lead to an increase in irradiance of a spot and thus, to an increase in contrast in the pattern image of the projection of the infrared light pattern. The infrared light pattern may have a periodic point pattern with a reduced number of spots, wherein each of the spots has a high luminance. Such a light pattern can ensure improved authentication using illumination sources and image generation unit behind a display. Moreover, the low number of spots can ensure complying with eye safety requirements and stability requirements. The allowed dose may be divided between the spots of the light pattern.

At least one of the infrared light spots may be associated with a beam divergence of 0.2° to 0.5°, preferably 0.1° to 0.3°. The term “beam divergence” as used herein is a broad term and is to be given its ordinary and customary meaning to a person of ordinary skill in the art and is not to be limited to a special or customized meaning. The term specifically may refer, without limitation, to at least one measure of an increase in at least one diameter and/or at least one diameter equivalent, such as a radius, with a distance from an optical aperture from which the beam emerges. The measure may be an angle or an angle equivalent. In the context of the present invention, typically, a beam divergence may be determined at 1—/e².

The pattern illumination source may comprises at least one pattern projector configured for generating the infrared light pattern. The pattern illumination source, e.g. the pattern projector, may comprise at least one emitter, in particular a plurality of emitters. The term “emitter” as used herein is a broad term and is to be given its ordinary and customary meaning to a person of ordinary skill in the art and is not to be limited to a special or customized meaning. The term specifically may refer, without limitation, to at least one arbitrary device configured for providing at least one light beam. The light beam may generate the infrared light pattern. The emitter may comprise at least one element selected from the group consisting of at least one laser source such as at least one semi-conductor laser, at least one double heterostructure laser, at least one external cavity laser, at least one separate confinement heterostructure laser, at least one quantum cascade laser, at least one distributed Bragg reflector laser, at least one polariton laser, at least one hybrid silicon laser, at least one extended cavity diode laser, at least one quantum dot laser, at least one volume Bragg grating laser, at least one Indium Arsenide laser, at least one Gallium Arsenide laser, at least one transistor laser, at least 50 one diode pumped laser, at least one distributed feedback lasers, at least one quantum well laser, at least one interband cascade laser, at least one semiconductor ring laser, at least one vertical cavity surface emitting laser (VCSEL); at least one non-laser light source such as at least one LED or at least one light bulb. For example, the pattern projector comprises at least one VCSEL, preferably a plurality of VCSELs. The plurality of VCSELs may be arranged in at least one array, e.g. comprising a matrix of VCSELs. The VCSELs may be arranged on the same substrate, or on different substrates. The term “vertical-cavity surface-emitting laser” as used herein is a broad term and is to be given its ordinary and customary meaning to a person of ordinary skill in the art and is not to be limited to a special or customized meaning. The term specifically may refer, without limitation, to a semiconductor laser diode configured for laser beam emission perpendicular with respect to a top surface. Examples for VCSELs can be found e.g. in en.wikipedia.org/wiki/Verticalcavity_surface-emitting_laser. VCSELs are generally known to the skilled person such as from WO 2017/222618 A. Each of the VCSELs is configured for generating at least one light beam. The VCSEL or the plurality of VCSELs may be configured for generating the desired spot number equal or below 4000 spots, preferably, equal or below 3000 spots, more preferably equal or below 2000 spots. The plurality of generated spots may be associated with the infrared light pattern. The VCSELs may be configured for emitting light beams at a wavelength range from 800 to 1000 nm. For example, the VCSELs may be configured for emitting light beams at 808 nm, 850 nm, 940 nm, and/or 980 nm. Preferably the VCSELs emit light at 940 nm, since terrestrial sun radiation has a local minimum in irradiance at this wavelength, e.g. as described in CIE 085-1989 “Solar spectral Irradiance”.

The pattern illumination source may comprise at least one optical element configured for increasing, e.g. duplicating, the number of spots, e.g. the spots generated by the pattern projector. The pattern illumination source, particularly the at least one optical element, may comprise at least one diffractive optical element (DOE) and/or at least one metasurface element. The DOE and/or the metasurface element may be configured for generating multiple light beams from a single incoming light beam. For example, a VCSEL projecting up to 2000 spots and an optical element comprising a plurality of metasurface elements may be used to duplicate the number of spots. Further arrangements, particularly comprising a different number of projecting VCSEL and/or at least one different optical element configured for increasing the number of spots may be possible. Other multiplication factors are possible. For example, a VCSEL or a plurality of VCSELs may be used and the generated laser spots may be duplicated by using at least one DOE.

The pattern illumination source may comprise at least one transfer device. The term “transfer device”, also denoted as “transfer system”, as used herein is a broad term and is to be given its ordinary and customary meaning to a person of ordinary skill in the art and is not to be limited to a special or customized meaning. The term specifically may refer, without limitation, to one or more optical elements which are adapted to modify the light beam, particularly the light beam used for generating at least a portion of the infrared light pattern, such as by modifying one or more of a beam parameter of the light beam, a width of the light beam or a direction of the light beam. The transfer device may comprise at least one imaging optical device . The transfer device specifically may comprise one or more of: at least one lens, for example at least one lens selected from the group consisting of at least one focus-tunable lens, at least one aspheric lens, at least one spherical lens, at least one Fresnel lens; at least one diffractive optical element; at least one concave mirror; at least one beam deflection element, preferably at least one mirror; at least one beam splitting element, preferably at least one of a beam splitting cube or a beam splitting mirror; at least one multilens system; at least one holographic optical element; at least one meta optical element. Specifically, the transfer device comprises at least one refractive optical lens stack. Thus, the transfer device may comprise a multi-lens system having refractive properties.

The light beam or light beams generated by the pattern illumination source may propagate parallel to an optical axis. The pattern illumination source may comprise at least one reflective element, preferably at least one prism, for deflecting the light beam onto the optical axis. As an example, the light beam or light beams, such as the laser light beam, and the optical axis may include an angle of less than 10°, preferably less than 5° or even less than 2°. Other embodiments, however, are feasible. Further, the light beam or light beams may be on the optical axis or off the optical axis. As an example, the light beam or light beams may be parallel to the optical axis having a distance of less 10 than 10 mm to the optical axis, preferably less than 5 mm to the optical axis or even less than 1 mm to the optical axis or may even coincide with the optical axis.

The term “flood illumination source” as used herein is a broad term and is to be given its ordinary and customary meaning to a person of ordinary skill in the art and is not to be limited to a special or customized meaning. The term specifically may refer, without limitation, to at least one arbitrary device configured for providing substantially continuous spatial illumination. The term “flood light” as used herein, is a broad term and is to be given its ordinary and customary meaning to a person of ordinary skill in the art and is not to be limited to a special or customized meaning. The term specifically may refer, without limitation, to substantially continuous spatial illumination, in particular diffuse and/or uniform illumination. The flood light has a wavelength in the infrared range, in particular in the near infrared range. The flood illumination source may comprise at least one LED or at least one least one VCSEL, preferably a plurality of VCSELs. The term “substantially continuous spatial illumination” as used herein is a broad term and is to be given its ordinary and customary meaning to a person of ordinary skill in the art and is not to be limited to a special or customized meaning. The term specifically may refer, without limitation, to uniform spatial illumination, wherein areas of non-uniform are possible. The area, e.g. covering a user, a portion of the user and/or a face of the user, illuminated from the flood illumination source, may be contiguous. Power may be spread over a whole field of illumination. In contrast, illumination provided by the light pattern may comprise at least two contiguous areas, in particular a plurality of contiguous areas, and/or power may be concentrated in small (compared to the whole field of illumination) areas of the field of illumination. The infrared flood illumination may be suitable for illuminating a contiguous area, in particular one contiguous area. The infrared pattern illumination may be suitable for illuminating at least two contiguous areas.

The flood illumination source may illuminate a measurement area, such as a user, a portion of the user and/or a face of the user, with a substantially constant illumination intensity. The term “constant” as used herein, is a broad term and is to be given its ordinary and customary meaning to a person of ordinary skill in the art and is not to be limited to a special or customized meaning. The term specifically may refer, without limitation, to a time aspect during an exposure time. The flood light may vary temporally and/or may be substantially constant over time. The term “substantially constant” as used herein, is a broad term and is to be given its ordinary and customary meaning to a person of ordinary skill in the art and is not to be limited to a special or customized meaning. The term specifically may refer, without limitation, to a completely constant illumination and embodiments in which deviations from a constant illumination of ≤±10%, preferably ≤+5%, more preferably ≤+2% are possible.

The term “image generation unit” as used herein is a broad term and is to be given its ordinary and customary meaning to a person of ordinary skill in the art and is not to be limited to a special or customized meaning. The term specifically may refer, without limitation, to at least one unit of the optoelectronic apparatus configured for generating at least one image. The image may be generated via a hardware and/or a software interface, which may be considered as the image generation unit. The term “image generation” as used herein is a broad term and is to be given its ordinary and customary meaning to a person of ordinary skill in the art and is not to be limited to a special or customized meaning. The term specifically may refer, without limitation, to capturing and/or generating and/or determining and/or recording at least one image by using the image generation unit. The image generation may comprise imaging and/or recording the image. The image generation may comprise capturing a single image and/or a plurality of images such as a sequence of images. For generating an image via a hardware and/or a software interface, the capturing and/or generating and/or determining and/or recording of the image may be caused and/or initiated by the hardware and/or the software interface. For example, the image generation may comprise recording continuously a sequence of images such as a video or a movie. The image generation may be initiated by a user action or may automatically be initiated, e.g. once the presence of at least one object or user within a field of view and/or within a predetermined sector of the field of view of the image generation unit is automatically detected.

The image generation unit may comprise at least one optical sensor, in particular at least one pixelated optical sensor. The image generation unit may comprise at least one CMOS sensor or at least one CCD chip. For example, the image generation unit may comprise at least one CMOS sensor, which may be sensitive in the infrared spectral range. The term “image” as used herein is a broad term and is to be given its ordinary and customary meaning to a person of ordinary skill in the art and is not to be limited to a special or customized meaning. The term specifically may refer, without limitation, to data recorded by using the optical sensor, such as a plurality of electronic readings from the CMOS or CCD chip. The image may comprise raw image data or may be a pre-processed image. For example, the pre-processing may comprise applying at least one filter to the raw image data and/or at least one background correction and/or at least one background subtraction.

For example, the image generation unit may comprise one or more of at least one monochrome camera e.g. comprising monochrome pixels, at least one color (e.g. RGB) camera e.g. comprising color pixels, at least one IR camera. The camera may be a CMOS camera. The camera may comprise at least one monochrome camera chip, e.g. a CMOS chip. The camera may comprise at least one color camera chip, e.g. an RGB CMOS chip. The camera may comprise at least one IR camera chip, e.g. an IR CMOS chip. For example, the camera may comprise monochrome, e.g. black and white, pixels and color pixels. The color pixels and the monochrome pixels may be combined internally in the camera. The camera generally may comprise a one-dimensional or two-dimensional array of image sensors, such as pixels.

As outlined, above, the image generation unit may be at least one camera. For example, the camera may be an internal and/or external camera of a device comprising the optoelectronic apparatus. As described in the above, the internal and/or external camera of the device may be accessed via a hardware and/or a software interface comprised by the optoelectronic apparatus, which is used as the image generation unit. In case, the device is or comprises a smartphone the image generating unit may be a front camera, such as a selfie camera, and/or back camera of the smartphone.

The image generation unit may have a field of view between 10°×10°and 75°×75°, preferably 55°×65°. For example, the field of view may be between 20°×20°and 65°×65°, more preferably 30°×30°and 60°×60°, most preferably 55°×65°. The image generation unit may have a resolution below 2 MP, preferably between 0.3 MP and 1.5 MP.

The image generation unit may comprise further elements, such as one or more optical elements, e.g. one or more lenses. As an example, the optical sensor may be a fix-focus camera, having at least one lens which is fixedly adjusted with respect to the camera. Alternatively, however, the camera may also comprise one or more variable lenses which may be adjusted, automatically or manually. The camera may comprise at least one optical filter, e.g. at least one bandpass filter. The bandpass filter may be matched to the spectrum of the light emitters. Other cameras, however, are feasible.

The term “pattern image” as used herein is a broad term and is to be given its ordinary and customary meaning to a person of ordinary skill in the art and is not to be limited to a special or customized meaning. The term specifically may refer, without limitation, to an image generated by the image generation unit while illuminating with the infrared light pattern, e.g. on an object and/or a user. The pattern image may comprise an image showing a user, in particular at least parts of the face of the user, while the user is being illuminated with the infrared light pattern, particularly on a respective area of interest comprised by the image. The pattern image may be generated by imaging and/or recording light reflected by an object and/or user, which is illuminated by the infrared light pattern. The pattern image showing the user may comprise at least a portion of the illuminated infrared light pattern on at least a portion the user. For example, the illumination by the pattern illumination source and the imaging by using the optical sensor may be synchronized, e.g. by using at least one control unit of the optoelectronic apparatus.

The term “flood image” as used herein is a broad term and is to be given its ordinary and customary meaning to a person of ordinary skill in the art and is not to be limited to a special or customized meaning. The term specifically may refer, without limitation, to an image generated by the image generation unit while illumination source is emitting infrared flood light, e.g. on an object and/or a user. The flood image may comprise an image showing a user, in particular the face of the user, while the user is being illuminated with the flood light. The flood image may be generated by imaging and/or recording light reflected by an object and/or user which is illuminated by the flood light. The flood image showing the user may comprise at least a portion of the flood light on at least a portion the user. For example, the illumination by the flood illumination source and the imaging by using the optical sensor may be synchronized, e.g. by using at least one control unit of the optoelectronic apparatus.

The image generation unit may be configured for imaging and/or recording the pattern image and the flood image at the same time or at different times. The image generation unit may be configured for imaging and/or recording the pattern image and the flood image at a at least partially overlapping measurement areas or equivalents of the measurement areas.

The optoelectronic apparatus may be comprised in a device. In particular, the optoelectronic apparatus may be part of the device. The device may comprise at least one display, wherein the infrared light pattern traverses the display while being emitted from the pattern illumination source and/or the infrared flood light traverses the display while being emitted from the flood illumination source. The display is at least partially transparent in at least one continuous area covering the pattern illumination source and/or the flood illumination source and/or the image generation unit.

The term “display” as used herein is a broad term and is to be given its ordinary and customary meaning to a person of ordinary skill in the art and is not to be limited to a special or customized meaning. The term specifically may refer, without limitation, to an arbitrary shaped device configured for displaying an item of information. The item of information may be arbitrary information such as at least one image, at least one diagram, at least one histogram, at least one graphic, text, numbers, at least one sign, an operating menu, and the like. The display may be or may comprise at least one screen. The display may have an arbitrary shape, e.g. a rectangular shape. The display may be a front display of the device.

The display may be or may comprise at least one organic light-emitting diode (OLED) display. As used herein, the term “organic light emitting diode” is a broad term and is to be given its ordinary and customary meaning to a person of ordinary skill in the art and is not to be limited to a special or customized meaning. The term specifically may refer, without limitation, to a light-emitting diode (LED) in which an emissive electroluminescent layer is a film of organic compound configured for emitting light in response to an electric current. The OLED display may be configured for emitting visible light.

The display, particularly a display area, may be made of and/or may be covered by glass. In particular, the display may comprise at least one glass cover.

The display is at least partially transparent. The term “at least partially transparent” as used herein is a broad term and is to be given its ordinary and customary meaning to a person of ordinary skill in the art and is not to be limited to a special or customized meaning. The term specifically may refer, without limitation, to a property of the display to allow light, in particular of a certain wavelength range, e.g. in the infrared spectral region, in particular in the near infrared spectral region, to pass at least partially through. For example, the display may be semitransparent in the near infrared region. For example, the display may have a transparency of 20 % to 50 % in the near infrared region. The display may have a different transparency for other wavelength ranges. The present invention may propose an optoelectronic apparatus comprising the image generation unit and two illumination sources that can be placed behind the display of a device. The transparent area(s) of the display can allow for operation of the optoelectronic apparatus behind the display. The display is an at least partially transparent display, as described above. The display may have a reduced pixel density and/or a reduced pixel size and/or may comprise at least one transparent conducting path. The transparent area(s) of the display may have a pixel density of 360-440 PPI (pixels per inch). Other areas of the display, e.g. non-transparent areas, may have pixels densities higher than 400 PPI, e.g. a pixel density of 460-500 PPI.

The display may comprise a display area. The term “display area” as used herein is a broad term and is to be given its ordinary and customary meaning to a person of ordinary skill in the art and is not to be limited to a special or customized meaning. The term specifically may refer, without limitation, to an active area of the display, in particular an area which is activatable. The display may have additional areas such as recesses or cutouts. The display may be at least partially transparent in at least one continuous area, preferably in at least two continuous areas. At least one of the continuous areas covers the image generation unit and/or the pattern illumination source and/or the flood illumination source at least partially. The pattern illumination source, the flood illumination source and the image generation unit may be placed in a direction of propagation of the infrared light pattern in front of the display.

The display may have a first area associated with a first pixel density (Pixels per inch (PPI)) value and a second area associated with a second pixel density value. Exemplarily the display may comprise the first area having a PPI value of less than 350 and/or the second area having a PPI value equal to or more than 400. The first pixel density value may be lower than the second pixel density value. The first pixel density value may be equal to or below 450 PPI, preferably from 300 to 440 PPI, more preferably 350 to 450 PPI. The second pixel density value may be 400 to 500 PPI, preferably 450 to 500 PPI. The first pixel density value may be associated with the at least one continuous area being at least partially transparent. The first pixel density value may be below 350 and the second pixel density value is equal to or more than 400.

As outlined above, known displays fulfilling these requirements are less appealing to users and the transparent area is desired to be decreased. Moreover, usually, covering the image generation unit with such a display can result in a low contrast because of the light transmission of 15 % to 50 % in transparent regions. The contrast may be defined as a difference between signal and backlight. In this case, the contrast can be considered to be reduced by the transmission. However, the contrast may be defined as a ratio of signal to background. In this case, the contrast may not be reduced by the transmission only, but by the diffraction in the spot pattern projection as the higher orders bring additional intensity besides the zero-th order. Diffraction may further takes place due to the structure of a display wiring leading to a further decrease in irradiance. Moreover, the spot pattern projected through a display can result in main spots corresponding to the pattern before traversing the display area with reduced intensity because higher order spots are generated. Both effects lead to a reduction in irradiance to about 3-5% of initial irradiance and the presence of undesired additional spots in the pattern. In particular, this effect may take place while leaving the device (first pass through the display) and entering the device (second pass through the display). The present invention allows for providing a sufficient irradiance and, thus, contrast in the pattern image. The contrast can be increased by decreasing the number of spots projected onto the user. This can lead to an increase in irradiance of a spot and thus, to an increase in contrast in an image of the projection of the spot pattern. Moreover, reducing of transparent areas in displays can be possible. Using such an optoelectronic apparatus can allow for a rearrangement of the position of a camera, e.g. from the outer most position of the display. Such a rearrangement can allow for an optimized wiring since a further position, the position of the image generation unit, can be optimized. This can decrease the used wiring or allow for an improved battery operation.

A relative distance between the flood illumination source and the pattern illumination source may be below 3.0 mm. A relative distance between the flood illumination source and the pattern illumination source may be below 3.0 mm. The distance between the flood and pattern illumination sources may define the distance between the far most distant points of the flood and pattern illumination sources. The relative distance between the flood illumination source and the pattern illumination source may be below 2.5 mm, preferably below 2.0 mm. A lower boundary for the relative distance may be 50 μm, preferably 60 um, more preferably 70 μm, even more preferably 80 μm, most preferably 100 μm.

The pattern illumination source and the flood illumination source may be combined into one module. For example, the pattern illumination source and the flood illumination source may be arranged on the same substrate, in particular having a minimum relative distance. The minimum relative distance may be defined by a physical extension of the flood illumination source and the pattern illumination source. Arranging the pattern illumination source and the flood illumination source having a relative distance below 3.0 mm can result in decreased space requirement of the two illumination sources. In particular, said illumination sources can even be combined into one module. Such a reduced space requirement can allow reducing the transparent area(s) in a display necessary for operation of the illumination source(s) behind the display.

In a further aspect of the invention, a use of an optoelectronic apparatus according to the present invention for authenticating a user of a device comprising the apparatus is disclosed.

In a further aspect of the invention, a device for authenticating a user of a device to perform at least one operation on the device that requires authentication is disclosed.

The device comprising:
at least one flood illumination source configured for emitting infrared flood light;
at least one pattern illumination source configured for emitting at least one infrared light pattern comprising a plurality of infrared light spots, wherein the number of infrared light spots is below or equal 4000 spots,;
at least one image generation unit configured for generating at least one pattern image while the pattern illumination source is emitting infrared light pattern and configured for generating at least one flood image while the flood illumination source is emitting infrared flood light;
at least one display, wherein the infrared light pattern traverses the display while being illuminated from the pattern illumination source and/or the infrared flood light traverses the display while being illuminated from the flood illumination source, wherein the display of the device is at least partially transparent in at least one continuous area covering the pattern illumination source, the flood illumination source and/or the image generation unit,
at least one authentication unit configured for performing at least one authentication process of a user using the flood image and the pattern image.

The device, in particular, may comprise at least one optoelectronic apparatus according to the present invention. Thus, for details, options and definitions, reference may be made to the device and the optoelectronic apparatus as discussed above or as described in further detail below.

The device may be selected from the group consisting of: a television device; a game console; a personal computer; a mobile device, particularly a cell phone, and/or a smart phone, and/or a tablet computer, and/or a laptop, and/or a tablet, and/or a virtual reality device, and/or a wearable, such as a smart watch; or another type of portable computer.

The term “authenticating” as used herein is a broad term and is to be given its ordinary and customary meaning to a person of ordinary skill in the art and is not to be limited to a special or customized meaning. The term specifically may refer, without limitation, to verifying an identity of a user. Specifically, the authentication may comprise distinguishing between the user from other humans or objects, in particular between authorized access from non-authorized accesses. The authentication may comprise verifying identity of a respective user and/or assigning identity to a user. The authentication may comprise generating and/or providing identity information, e.g. to other devices or units such as to at least one authorization unit for authorization for providing access to the device. The identify information may be proofed by the authentication. For example, the identity information may be and/or may comprise at least one identity token. In case of successful authentication an image of a face recorded by the image generation unit may be verified to be an image of the user's face and/or the identity of the user is verified. The authenticating may be performed using at least one authentication process. The authentication process may comprise a plurality of steps such as at least one face detection on the flood image and at least one identifying step in which an identity is assigned to the detected face and/or at least one identity check and/or verifying an identity of the user is performed.

The term “authentication unit” as used herein is a broad term and is to be given its ordinary and customary meaning to a person of ordinary skill in the art and is not to be limited to a special or customized meaning. The term specifically may refer, without limitation, to at least one unit configured for performing at least one authentication process of a user. The authentication unit may be or may comprise at least one processor. The processor may be an arbitrary logic circuitry configured for performing basic operations of a computer or system, and/or, generally, to a device which is configured for performing calculations or logic operations. In particular, the processor may be configured for processing basic instructions that drive the computer or system. As an example, the processor may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. In particular, the processor may be a multi-core processor. Specifically, the processor may be or may comprise a central processing unit (CPU). Additionally or alternatively, the processor may be or may comprise a microprocessor, thus specifically the processor's elements may be contained in one single integrated circuitry (IC) chip. Additionally or alternatively, the processor may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The processor specifically may be configured, such as by software programming, for performing one or more evaluation operations. At least one or any component of a computer program configured for performing the authentication process may be executed by the processing device. Alternatively or in addition, the authentication unit may be or may comprise a connection interface. The connection interface may be configured to transfer data from the device to a remote device; or vice versa. At least one or any component of a computer program configured for performing the authentication process may be executed by the remote device.

For example, the authentication unit may perform at least one face detection using the flood image. The face detection may be performed locally on the device. Face identification, i.e. assigning an identity to the detected face, however, may be performed remotely, e.g. in the cloud, e.g. especially when identification needs to be done and not only verification. User templates can be stored at the remote device, e.g. in the cloud, and would not need to be stored locally. This can be an advantage in view of storage space and security. The authentication unit may be configured for identifying the user based on the flood image. Particularly therefore, the authentication unit may forward data to a remote device. Alternatively or in addition, the authentication unit may perform the identification of the user based on the flood image, particularly by running an appropriate computer program having a respective functionality. The term “identifying” as used herein is a broad term and is to be given its ordinary and customary meaning to a person of ordinary skill in the art and is not to be limited to a special or customized meaning. The term specifically may refer, without limitation, to assigning an identity to a detected face and/or at least one identity check and/or verifying an identity of the user.

The authentication process may comprise a plurality of steps. For example, the authentication process may comprise performing at least one face detection. The face detection step may comprise analyzing the flood image. In addition, for example, the authentication process may comprise identifying. The identifying may comprise assigning an identity to a detected face and/or at least one identity check and/or verifying an identity of the user. The identifying may comprise performing a face verification of the imaged face to be the user's face. The identifying the user may comprise matching the flood image, e.g. showing a contour of parts of the user, in particular parts of the user's face, with a template. The identifying of the user may comprise determining if the imaged face is the face of the user, in particular if the imaged face corresponds to at least one image of the user's face stored in at least one memory, e.g. of the device.

The analyzing of the flood image may comprise one or more of the following: a filtering; a selection of at least one region of interest; a formation of a difference image between the flood image and at least one offset; an inversion of flood image; a background correction; a decomposition into color channels; a decomposition into hue; saturation; and brightness channels; a frequency decomposition; a singular value decomposition; applying a Canny edge detector; applying a Laplacian of Gaussian filter; applying a Difference of Gaussian filter; applying a Sobel operator; applying a Laplace operator; applying a Scharr operator; applying a Prewitt operator; applying a Roberts operator; applying a Kirsch operator; applying a high-pass filter; applying a low-pass filter; applying a Fourier transformation; applying a Radon-transformation; applying a Hough-transformation; applying a wavelet-transformation; a thresholding; creating a binary image. The region of interest may be determined manually by a user or may be determined automatically, such as by recognizing the user within the image. In particular, the analyzing of the flood image may comprise using at least one image recognition technique, in particular a face recognition technique. An image recognition technique comprises at least one process of identifying the user in an image. The image recognition may comprise using at least one technique selected from the technique consisting of: color-based image recognition, e.g. using features such as template matching; image segmentation and/or blob analysis e.g. using size, or shape; machine learning and/or deep learning e.g. using at least one convolutional neural network.

The analyzing of the flood image may comprise determining a plurality of facial features. The analyzing may comprise comparing, in particular matching, the determined facial features with template features. The template features may be features extracted from at least one template. The template may be or may comprise at least one image generated in an enrollment process, e.g. when initializing the device. Template may be an image of an authorized user. The template features and/or the facial feature may comprise a vector. Matching of the features may comprise determining a distance between the vectors. The identifying of the user may comprise comparing the distance of the vectors to a least one predefined limit, wherein the user is successfully identified in case the distance is ≤the predefined limit at least within tolerances. The user declining and/or rejected otherwise.

For example, the image recognition may comprise using at least one model, in particular a trained model comprising at least one face recognition model. The analyzing of the flood image may be performed by using a face recognition system, such as FaceNet, e.g. as described in Florian Schroff, Dmitry Kalenichenko, James Philbin, “FaceNet: A Unified Embedding for Face Recognition and Clustering”, arXiv: 1503.03832. The trained model may comprises at least one convolutional neural network. For example, the convolutional neural network may be designed as described in M. D. Zeiler and R. Fergus, “Visualizing and understanding convolutional networks”, CoRR, abs/1311.2901, 2013, or C. Szegedy et al., “Going deeper with convolutions”, CoRR, abs/1409.4842, 2014. For more details with respect to convolutional neural network for the face recognition system reference is made to Florian Schroff, Dmitry Kalenichenko, James Philbin, “FaceNet: A Unified Embedding for Face Recognition and Clustering”, arXiv: 1503.03832. As training data labelled image data from an image database may be used. Specifically, labeled faces may be used from one or more of G. B. Huang, M. Ramesh, T. Berg, and E. Learned-Miller, “Labeled faces in the wild: A database for studying face recognition in unconstrained environments”, Technical Report 07-49, University of Massachusetts, Amherst, October 2007, the Youtube® Faces Database as described in L. Wolf, T. Hassner, and I. Maoz, “Face recognition in unconstrained videos with matched background similarity”, in IEEE Conf. on CVPR, 2011, or Google® Facial Expression Comparison dataset. The training of the convolutional neural network may be performed as described in Florian Schroff, Dmitry Kalenichenko, James Philbin, “FaceNet: A Unified Embedding for Face Recognition and Clustering”, arXiv: 1503.03832.

The authentication unit may be further configured for determining material data based on the pattern image. Particularly therefore, the authentication unit may forward data to a remote device. Alternatively or in addition, the authentication unit may perform the material determination based on the pattern image, particularly by running an appropriate computer program having a respective functionality. Particularly by considering the material as a parameter for validating the authentication process, the authentication process may be robust against being outwitted by using a recorded image of the user.

The authentication unit may be configured for extracting the material data from the pattern image by beam profile analysis of the light spots. With respect to beam profile analysis reference is made to WO 2018/091649 A1, WO 2018/091638 A1 and WO 2018/091640 A1, the full content of which is included by reference. Beam profile analysis can allow for providing a reliable classification of scenes based on a few light spots. Each of the light spots of the pattern image may comprise a beam profile. As used herein, the term “beam profile” may generally refer to at least one intensity distribution of the light spot on the optical sensor as a function of the pixel. The beam profile may be selected from the group consisting of a trapezoid beam profile; a triangle beam profile; a conical beam profile and a linear combination of Gaussian beam profiles.

The authentication unit may be configured for outsourcing at least one step of the authentication process, such as the identifying of the user, and/or at least one step of the validation of the authentication process, such as the consideration of the material data, to a remote device, specifically a server and/or a cloud server. The device and the remote device may be part of a computer network, particularly the internet. Thereby, the device may be used as a field device that is used by the user for generating data required in the authentication process and/or its validation. The device may transmit the generated data and/or data associated to an intermediate step of the authentication process and/or its validation to the remote device. In such a scenario, the authentication unit may be and/or may comprise a connection interface configured for transmitting information to the remote device. Data generated by the remote device used in the authentication process and/or its validation may further be transmitted to the device. This data may be received by the connection interface comprised by the device. The connection interface may specifically be configured for transmitting or exchanging information. In particular, the connection interface may provide a data transfer connection. As an example, the connection interface may be or may comprise at least one port comprising one or more of a network or internet port, a USB-port, and a disk drive.

It is emphasized that data from the device may be transmitted to a specific remote device depending on at least one circumstance, such as a date, a day, a load of the specific remote device, and so on. The specific remote device may not be selected by the field device. Rather a further device may select to which specific remote device the data may be transmitted. The authentication process and and/or the generation of validation data may involve a use of several different entities of the remote device. At least one entity may generate intermediate data and transmit the intermediate data to at least one further entity.

The authentication unit may be configured for using a facial recognition authentication process operating on the flood image, the pattern image and/or extracted material data. The authentication unit may be configured for extracting material data from the pattern image.

In an embodiment, extracting material data from the pattern image may comprise generating the material type and/or data derived from the material type. Preferably, extracting material data may be based on the pattern image. Material data may be extracted by using at least one model. Extracting material data may include providing the pattern image to a model and/or receiving material data from the model. Providing the image to a model may comprise and may be followed by receiving the pattern image at an input layer of the model or via a model loss function. The model may be a data-driven model. Data-driven model may comprise a convolutional neural network and/or an encoder decoder structure such as an autoencoder. Other examples for generating a representation may be FFT, wavelets, deep learning, like CNNs, energy models, normalizing flows, GANs, vision transformers, or transformers used for natural language processing, Autoregressive Image Modeling, Normalizing Flows, Deep Autoencoders, Deep Energy-Based Models. Supervised or unsupervised schemes may be applicable to generate a representation, also embedding in e.g. cosine or Euclidian metric in ML language. The data-driven model may be parametrized according to a training data set including at least one image and material data, preferably at least one pattern image and material data. In another embodiment, extracting material data may include providing the image to a model and/or receiving material data from the model. In another embodiment, the data-driven model may be trained according to a training data set including at least one image and material data. In another embodiment, the data-driven model may be parametrized according to a training data set including at least one image and material data. The data-driven model may be parametrized according to a training data set to receive the image and provide material data based on the received image. The data-driven model may be trained according to a training data set to receive the image and provide material data as output based on the received image. The training data set may comprise at least one image and material data, preferably material data associated with the at least one image. The image may comprise a representation of the image. The representation may be a lower dimensional representation of the image. The representation may comprise at least a part of the data or the information associated with the image. The representation of an image may comprise a feature vector. In an embodiment, determining a representation, in particular a lower-dimensional representation may be based on principal component analysis (PCA) mapping or radial basis function (RBF) mapping. Determining a representation may also be referred to as generating a representation. Generating a representation based on PCA mapping may include clustering based on features in the pattern image and/or partial image. Additionally or alternatively, generating a representation may be based on neural network structures suitable for reducing dimensionality. Neural network structures suitable for reducing dimensionality may comprise encoder and/or decoder. In an example, neural network structure may be an autoencoder. In an example, neural network structure may comprise a convolutional neural network (CNN). The CNN may comprise at least one convolutional layer and/or at least one pooling layer. CNNs may reduce the dimensionality of a partial image and/or an image by applying a convolution, e.g. based on a convolutional layer, and/or by pooling. Applying a convolution may be suitable for selecting feature related to material information of the pattern image.

In an embodiment, a model may be suitable for determining an output based on an input. In particular, model may be suitable for determining material data based on an image as input. A model may be a deterministic model, a data-driven model or a hybrid model. The deterministic model, preferably, reflects physical phenomena in mathematical form, e.g., including first-principles models. A deterministic model may comprise a set of equations that describe an interaction between the material and the patterned electromagnetic radiation thereby resulting in a condition measure, a vital sign measure or the like. A data-driven model may be a classification model. A hybrid model may be a classification model comprising at least one machine-learning architecture with deterministic or statistical adaptations and model parameters. Statistical or deterministic adaptations may be introduced to improve the quality of the results since those provide a systematic relation between empiricism and theory. In an embodiment, the data-driven model may be a classification model. The classification model may comprise at least one machine-learning architecture and model parameters. For example, the machine-learning architecture may be or may comprise one or more of: linear regression, logistic regression, random forest, piecewise linear, nonlinear classifiers, support vector machines, naive Bayes classifications, nearest neighbors, neural networks, convolutional neural networks, generative adversarial networks, support vector machines, or gradient boosting algorithms or the like. In the case of a neural network, the model can be a multi-scale neural network or a recurrent neural network (RNN) such as, but not limited to, a gated recurrent unit (GRU) recurrent neural network or a long short-term memory (LSTM) recurrent neural network. The data-driven model may be parametrized according to a training data set. The data-driven model may be trained based on the training data set. Training the model may include parametrizing the model. The term training may also be denoted as learning. The term specifically may refer, without limitation, to a process of building the classification model, in particular determining and/or updating parameters of the classification model. Updating parameters of the classification model may also be referred to as retraining. Retraining may be included when referring to training herein. In an embodiment, the training data set may include at least one image and material information.

In an embodiment, extracting material data from the image with a data-driven model may comprise providing the image to a data-driven model. Additionally or alternatively, extracting material data from the image with a data-driven model may comprise may comprise generating an embedding associated with the image based on the data-driven model. An embedding may refer to a lower dimensional representation associated with the image such as a feature vector. Feature vector may be suitable for suppressing the background while maintaining the material signature indicating the material data. In this context, background may refer to information independent of the material signature and/or the material data. Further, background may refer to information related to biometric features such as facial features. Material data may be determined with the data-driven model based on the embedding associated with the image.

Additionally or alternatively, extracting material data from the image by providing the image to a data-driven model may comprise transforming the image into material data, in particular a material feature vector indicating the material data. Hence, material data may comprise further the material feature vector and/or material feature vector may be used for determining material data.

In an embodiment, authentication process may be validated based on the extracted material data.

In an embodiment, the validating based on the extracted material data may comprise determining if the extracted material data corresponds a desired material data. Determining if extracted material data matches the desired material data may be referred to as validating. Allowing or declining the user and/or object to perform at least one operation on the device that requires authentication based on the material data may comprise validating the authentication or authentication process. Validating may be based on material data and/or image. Determining if the extracted material data corresponds a desired material data may comprise determining a similarity of the extracted material data and the desired material data. Determining a similarity of the extracted material data and the desired material data may comprise comparing the extracted material data with the desired material data. Desired material data may refer to predetermined material data. In an example, desired material data may be skin. It may be determined if material data may correspond to the desired material data. In the example, material data may be non-skin material or silicon. Determining if material data corresponds to a desired material data may comprise comparing material data with desired material data. A comparison of material data with desired material data may result in a allowing and/or declining the user and/or object to perform at least one operation that requires authentication. In the example, skin as desired material data may be compared with non-skin material or silicon as material data and the result may be declination since silicon or non-skin material may be different from skin.

In an embodiment, the authentication process or its validation may include generating at least one feature vector from the material data and matching the material feature vector with associate reference template vector for material.

The authentication unit may be configured for authenticating the user in case the user can be identified and/or if the material data matches the desired material data. The device may comprise at least one authorization unit configured for allowing the user to perform at least one operation on the device, e.g. unlocking the device, in case of successful authentication of the user or declining the user to perform at least one operation on the device in case of non-successful authentication. Thereby, the user may become aware of the result of the authentication.

As already indicated in the above, a relative distance between the flood illumination source and the pattern illumination source may be below 3.0 mm.

In a further aspect, the present invention discloses a method for authenticating a user of a device to perform at least one operation on the device that requires authentication.

The device comprising a display and the method comprising:
a. illuminating the user with at least one infrared light pattern from at least one pattern illumination source of the device, wherein the number of infrared light spots is below or equal 4000 spots;
b. illuminating the user with infrared flood light from at least one flood illumination source of the device,
c. generating at least one pattern image with an image generation unit of the device showing the user, in particular at least parts of the face of the user, while the user is being illuminated with the infrared light pattern, and generating at least one image with an image generation unit of the device showing the user while the user is being illuminated with the infrared flood light, wherein the display of the device is at least partially transparent in at least one continuous area covering the pattern illumination source, the flood illumination source and/or the image generation unit,
d. identifying the user based on the flood image by using at least one authentication unit of the device,
e. extracting material data from the at least one pattern image by using the authentication unit; and
f. allowing the user to perform at least one operation on the device that requires authentication based on the material data and the identifying.

The method steps may be performed in the given order or may be performed in a different order. Further, one or more additional method steps may be present which are not listed. Further, one, more than one or even all of the method steps may be performed repeatedly. For details, options and definitions, reference may be made to the optoelectronic apparatus and the device as discussed above. Thus, specifically, the method may comprise using the device according to the present invention, such as according to one or more of the embodiments given above or given in further detail below.

The identifying of the user may comprise matching the flood image with a template.

The method may comprise using a facial recognition authentication process operating on the flood image, the pattern image and/or extracted material data. The pattern image and/or the image showing the user while the user is being illuminated with the infrared flood light may be showing at least a portion of a face of the user.

All described method steps may be performed by using the device. Therefore, the single processing device may be configured to exclusively perform at least one computer program, in particular at least one line of computer program code configured to execute at least one algorithm, as used in at least one of the embodiments of the method according to the present invention. Herein, the computer program as executed on the single processing device may comprise all instructions causing the computer to carry out the method. Alternatively, or in addition, at least one method step may be performed by using at least one remote device, especially selected from at least one of a server or a cloud server, particularly when the device and the remote device may be part of a computer network. In this case, the computer program may comprise at least one remote component to be executed by the at least one remote processing device to carry out the at least one method step. The remote component may have the functionality of performing the identifying of the user and/or the extraction of the material data. Further, the computer program may comprise at least one interface configured to forward to and/or receive data from the at least one remote component of the computer program.

The method may comprise allowing or declining the user to perform at least one operation on the device. In an embodiment, allowing or declining the user to perform at least one operation on the device that requires authentication based on the material data may include allowing the user to perform at least one operation on the device that requires authentication if the material data matches desired material data and/or authentication may be successful. Desired material data may be predetermined material data. Authentication may be successful if the user can be identified and/or if the material data matches desired material data. Further, allowing or declining the object to perform at least one operation on the device that requires authentication based on the material data may include declining to perform at least one operation on the device that requires authentication if the material data does not match desired material data and/or authentication may be unsuccessful. Authentication may be unsuccessful if the pattern image cannot be matched with an image template and/or if the material data does not match the desired material data.

At least one operation on the device that requires authentication may be access to the device, e.g. unlocking the device, and/or access to an application, preferably associated with the device and/or access to a part of an application, preferably associated with the device. In an embodiment, allowing the user to access a resource may include allowing the user to perform at least one operation with a device and/or system. The resource may be a device, a system, a function of a device, a function of a system and/or an entity. Additionally and/or alternatively, allowing the user to access a resource may include allowing the user to access an entity. The entity may be physical entity and/or virtual entity. The virtual entity may be a database for example. The physical entity may be an area with restricted access. The area with restricted access may be one of the following: security areas, rooms, apartments, vehicles, parts of the before mentioned examples, or the like. Device and/or system may be locked. The device and/or the system may only be unlocked by authorized user.

The term “user” as used herein is a broad term and is to be given its ordinary and customary meaning to a person of ordinary skill in the art and is not to be limited to a special or customized meaning. The term specifically may refer, without limitation, to a person intended to and/or using the device.

The method may be computer implemented. The term “computer implemented” as used herein is a broad term and is to be given its ordinary and customary meaning to a person of ordinary skill in the art and is not to be limited to a special or customized meaning. The term specifically may refer, without limitation, to a method involving at least one computer and/or at least one computer network. The computer and/or computer network may comprise at least one processor which is configured for performing at least one of the method steps of the method according to the present invention. Specifically, each of the method steps is performed by the computer and/or computer network. The method may be performed completely automatically, specifically without user interaction.

Further disclosed and proposed herein is a computer program including computer-executable instructions for performing the method according to the present invention in one or more of the embodiments enclosed herein when the program is executed on a computer or computer network. Specifically, the computer program may be stored on a computer-readable data carrier and/or on a computer-readable storage medium. The computer program may be executed on at least one processor comprised by the optoelectronic apparatus and/or the device. The computer program may generate input data by accessing and/or controlling at least one unit of the optoelectronic apparatus and/or the device, such as the pattern illumination source and/or the flood illumination source and/or the image generation unit. The computer program may generate outcome data based on the input data, particularly by using the authentication unit.

As used herein, the terms “computer-readable data carrier” and “computer-readable storage medium” specifically may refer to non-transitory data storage means, such as a hardware storage medium having stored thereon computer-executable instructions. The stored computer-executable instruction may be associate with the computer program. The computer-readable data carrier or storage medium specifically may be or may comprise a storage medium such as a random-access memory (RAM) and/or a read-only memory (ROM).

Thus, specifically, one, more than one or even all of method steps a. to f. as indicated above may be performed by using a computer or a computer network, preferably by using a computer program.

Further disclosed and proposed herein is a computer program product having program code means, in order to perform the method according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method according to one or more of the embodiments disclosed herein.

Further disclosed and proposed herein is a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Further disclosed and proposed herein is a non-transient computer-readable medium including instructions that, when executed by one or more processors, cause the one or more processors to perform the method according to one or more of the embodiments disclosed herein.

Finally, disclosed and proposed herein is a modulated data signal which contains instructions readable by a computer system or computer network, for performing the method according to one or more of the embodiments disclosed herein.

Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method ac-cording to one of the embodiments described in this description, if the program code means are executed on a computer or on a computer network.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Overall, in the context of the present invention, the following embodiments are regarded as preferred:

In an embodiment, an optoelectronic apparatus is disclosed, the optoelectronic apparatus comprising:
at least one pattern illumination source configured for emitting at least one infrared light pattern comprising a plurality of infrared light spots, wherein the number of infrared light spots is below or equal 4000 spots,
at least one flood illumination source configured for emitting infrared flood light,
at least one image generation unit configured for generating at least one pattern image while the pattern illumination source is emitting the infrared light pattern and configured for generating at least one flood image while the flood illumination source is emitting infrared flood light.

In an embodiment, the optoelectronic apparatus is comprised in a device, wherein the device comprises at least one display, wherein the infrared light pattern traverses the display while being emitted from the pattern illumination source and/or the infrared flood light traverses the display while being emitted from the flood illumination source, wherein the display is at least partially transparent in at least one continuous area covering the pattern illumination source, the flood illumination source and/or the image generation unit.

In an embodiment, the display comprises
a first area having a pixels per inch value, PPI, of less than 350 and
a second area having a PPI value equal to or more than 400.

In an embodiment, the infrared light pattern comprises equal to or less than 3000 spots, preferably equal to or less than 2000 spots.

### In an Embodiment, the Spots Have a Circular Shape.

In an embodiment, the infrared light is coherent, wherein the infrared light pattern is a coherent infrared light pattern.

In an embodiment, the infrared light pattern is a hexagonal pattern, preferably a hexagonal infrared light pattern, preferably a ⅖ hexagonal infrared light pattern.

In an embodiment, at least one of the infrared light spots is associated with a beam divergence of 0.2° to 0.5°, preferably 0.1° to 0.3°.

In an embodiment, the infrared light pattern is a near infrared light pattern.

In an embodiment, the image generation unit has a field of view between 10°×10° and 75°×75°, preferably 55°×65°, more preferably the field of view is between 20°×20° and 65°×65°, more preferably 30°×30° and 60°×60°, most preferably 55°×65.

In an embodiment, the image generation unit has a resolution below 2 MP, preferably between 0.3 MP and 1.5 MP.

In an embodiment, the image generation unit comprises at least one CMOS sensor or at least one CCD chip.

In an embodiment, the pattern illumination source comprises at least one pattern projector configured for generating the infrared light pattern.

In an embodiment, the pattern illumination source, such as the pattern projector, comprises at least one least one vertical cavity surface-emitting laser (VCSEL), preferably a plurality of VCSELS.

In an embodiment, the pattern illumination source comprises at least one optical element configured for increasing the number of spots, wherein the at least one optical element comprises at least one diffractive optical element (DOE) and/or at least one metasurface element.

In an embodiment, a relative distance between the flood illumination source and the pattern illumination source is below 3.0 mm

In an embodiment, the relative distance between the flood illumination source and the pattern illumination source is below 2.5 mm, preferably below 2.0 mm.

In an embodiment, a use of an optoelectronic apparatus according to any one of the preceding Embodiments for authenticating a user of a device comprising the apparatus is disclosed.

In an embodiment, a device for authenticating a user of a device to perform at least one operation on the device that requires authentication is disclosed, the device comprising:
at least one flood illumination source configured for emitting infrared flood light;
at least one pattern illumination source configured for emitting at least one infrared light pattern comprising a plurality of infrared light spots, wherein the number of infrared light spots is below or equal 4000 spots;
at least one image generation unit configured for generating at least one pattern image while the pattern illumination source is emitting the infrared light pattern and configured for generating at least one flood image while the flood illumination source is emitting infrared flood light;
at least one display, wherein the infrared light pattern traverses the display while being illuminated from the pattern illumination source and/or the infrared flood light traverses the display while being illuminated from the flood illumination source, wherein the display of the device is at least partially transparent in at least one continuous area covering the pattern illumination source, the flood illumination source and/or the image generation unit,
at least one authentication unit configured for performing at least one authentication process of a user using the flood image and the pattern image.

In an embodiment, the display is or comprises at least one organic light-emitting diode (OLED) display.

In an embodiment, the display comprises a display area.

In an embodiment, the display is made of and/or is covered by glass.

In an embodiment, the display of the device is at least partially transparent in at least two continuous areas.

In an embodiment, the display has a first area associated with a first pixel density value and a second area associated with a second pixel density value, wherein the first pixel density value is lower than the second pixel density value, preferably the first pixel density value is equal or below 450 PPI.

In an embodiment, the first pixel density value is associated with the at least one continuous area being at least partially transparent.

In an embodiment, the first pixel density value is below 350 and the second pixel density value is equal to or more than 400.

In an embodiment, the number of number of infrared light spots may be below 2000 and/or above 0, preferably above 5, more preferably above 10, most preferably above 100.

In an embodiment, the device is selected from the group consisting of: a television device; a game console; a personal computer; a mobile device, particularly a cell phone, and/or a smart phone, and/or a tablet computer, and/or a laptop, and/or a tablet, and/or a virtual reality device, and/or a wearable, such as a smart watch; or another type of portable computer.

In an embodiment, the authentication unit is configured for using a facial recognition authentication process operating on the pattern image, the flood image and/or extracted material data.

In an embodiment, the device comprises at least one optoelectronic apparatus according to any one of the preceding Embodiments referring to an optoelectronic apparatus.

In an embodiment, a relative distance between the flood illumination source and the pattern illumination source is below 3.0 mm In an embodiment, a method for authenticating a user of a device to perform at least one operation on the device that requires authentication is disclosed, the device comprising a display and the method comprising:
a. illuminating the user with at least one infrared light pattern from at least one pattern illumination source of the device;
b. illuminating the user with infrared flood light from at least one flood illumination source of the device,
c. generating at least one pattern image with an image generation unit of the device showing the user while the user is being illuminated with the infrared light pattern, and generating at least one image with an image generation unit of the device showing the user while the user is being illuminated with the infrared flood light, wherein the display of the device is at least partially transparent in at least one continuous area covering the pattern illumination source, the flood illumination source and/or the image generation unit,
d. identifying the user based on the flood image by using at least one authentication unit of the device,
e. extracting material data from the at least one pattern image by using the authentication unit; and
f. allowing the user to perform at least one operation on the device that requires authentication based on the material data and the identifying.

In an embodiment, the method comprises using a facial recognition authentication process operating on the pattern image, the flood image and/or extracted material data.

In an embodiment, the pattern image and/or the image showing the user while the user is being illuminated with the infrared flood light is showing at least a portion of a face of the user.

In an embodiment, the identifying of the user comprises matching the flood image with a template.

In an embodiment, the distance between the flood illumination source and the pattern illumination source is below 3.0 mm

In an embodiment, the method is computer-implemented.

In an embodiment, a computer program comprising instructions is disclosed which, when the program is executed by the device according to any one of the preceding Embodiments referring to a device, cause the device to perform the method according to any one of the preceding Embodiments referring to a method.

In an embodiment, a computer-readable storage medium comprising instructions is disclosed which, when the instructions are executed by the device according to any one of the preceding Embodiments referring to a device, cause the device to perform the method according to any one of the preceding Embodiments referring to a method.

In an embodiment, a non-transient computer-readable medium including instructions is disclosed that, when executed by one or more processors, cause the one or more processors to perform the method according to any one of the preceding Embodiments referring to a method.

### BRIEF DESCRIPTION OF THE FIGURES

Further optional details and features of the invention are evident from the description of preferred exemplary embodiments which follows in conjunction with the dependent claims. In this context, the particular features may be implemented in an isolated fashion or in combination with other features. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 shows an embodiment of a device according to the present invention;

FIG. 2 shows an embodiment of a method according to the present invention; and

FIG. 3 shows a further embodiment of a device according to the present invention.

### DETAILED DESCRIPTION OF THE EMBODIMENTS

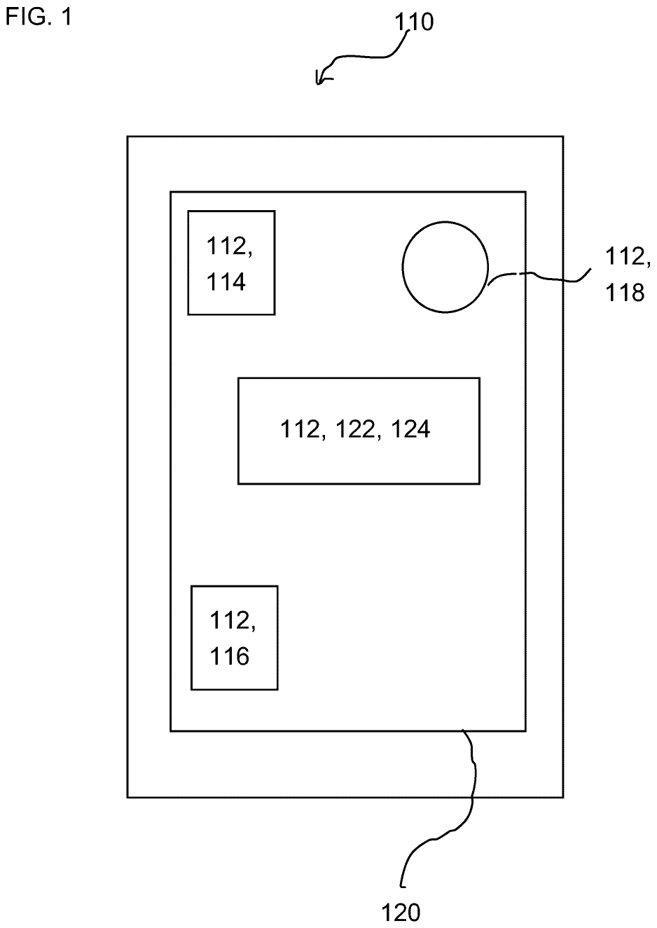

FIG. 1 shows an embodiment of a device 110 of the present invention in a highly schematic fashion. For example, the device 110 may be selected from the group consisting of: a television device; a game console; a personal computer; a mobile device, particularly a cell phone, and/or a smart phone, and/or a tablet computer, and/or a laptop, and/or a tablet, and/or a virtual reality device, and/or a wearable, such as a smart watch; or another type of portable computer.

In this embodiment, the device 110 comprises an optoelectronic apparatus 112 according to the present invention. The optoelectronic apparatus 112 comprises at least one pattern illumination source 114 configured for emitting at least one infrared light pattern comprising a plurality of infrared light spots. The number of infrared light spots is below or equal 4000 spots.

The pattern illumination source 114 may be configured for generating or providing at least one light pattern, in particular at least one infrared light pattern. The light pattern may comprise a plurality of light spots. The light spot may be at least partially spatially extended. The infrared light pattern may be a near infrared light pattern. The infrared light may be coherent. The infrared light pattern may be a coherent infrared light pattern. The pattern illumination source 114 may be configured for emitting light at a single wavelength, e.g. in the near infrared region. In other embodiments, the pattern illumination source 114 may be adapted to emit light with a plurality of wavelengths, e.g. for allowing additional measurements in other wavelengths channels. The infrared light pattern may comprise at least one regular and/or constant and/or periodic pattern such as a triangular pattern, a rectangular pattern, a hexagonal pattern or a pattern comprising further convex tilings. For example, the infrared light pattern is a hexagonal pattern, preferably a hexagonal infrared light pattern, preferably a ⅖ hexagonal infrared light pattern. Using a periodical ⅖ hexagonal pattern can allow distinguishing between artefacts and usable signal.

The infrared light pattern may comprise at least one point pattern. The infrared light pattern has a low point density. The number of infrared light spots is below or equal 4000 spots. The infrared light pattern may comprise equal to or less than 3000 spots, preferably equal to or less than 2000 spots. The spots may have a circular shape. Further shapes are possible. The infrared light pattern may have a low point density, in particular in comparison with other structured light techniques having typically a point density of 10 k-30 k in a field of view of 5×38°. Using such a low point density may allow compensating for the above-mentioned diffraction loss. By decreasing the number of spots projected onto an object and/or a user, a contrast in the pattern image may be increased. Increasing the number of points would decrease the irradiance per point. The decreased number of spots may lead to an increase in irradiance of a spot and thus, to an increase in contrast in the pattern image of the projection of the infrared light pattern. The infrared light pattern may have a periodic point pattern with a reduced number of spots, wherein each of the spots has a high irradiance. Such a light pattern can ensure improved authentication using the pattern illumination source 114 and, as described above, at least one flood illumination source 116, at least one image generation unit 118, behind a display 120. Moreover, the low number of spots can ensure complying with eye safety requirements and stability requirements. The allowed dose may be divided between the spots of the light pattern.

At least one of the infrared light spots may be associated with a beam divergence of 0.2° to 0.5°, preferably 0.1° to 0.3°.

The pattern illumination source 114 may comprises at least one pattern projector configured for generating the infrared light pattern. The pattern illumination source, e.g. the pattern projector, may comprise at least one emitter, in particular a plurality of emitters. The emitter may comprise at least one element selected from the group consisting of at least one laser source such as at least one semi-conductor laser, at least one double heterostructure laser, at least one external cavity laser, at least one separate confinement heterostructure laser, at least one quantum cascade laser, at least one distributed Bragg reflector laser, at least one polariton laser, at least one hybrid silicon laser, at least one extended cavity diode laser, at least one quantum dot laser, at least one volume Bragg grating laser, at least one Indium Arsenide laser, at least one Gallium Arsenide laser, at least one transistor laser, at least 50 one diode pumped laser, at least one distributed feedback lasers, at least one quantum well laser, at least one interband cascade laser, at least one semiconductor ring laser, at least one vertical cavity surface emitting laser (VCSEL); at least one non-laser light source such as at least one LED or at least one light bulb. For example, the pattern illumination source 114, e.g. the pattern projector comprises at least one least one VCSEL, preferably a plurality of VCSELs. The plurality of VCSELs may be arranged in at least array, e.g. comprising a matrix of VCSELs. The VCSELs may be arranged on a common substrate or on different substrates. Examples for VCSELs can be found e.g. in en. wikipedia. org/wiki/Verticalcavity_surface-emitting_laser. VCSELs are generally known to the skilled person such as from WO 2017/222618 A. Each of the VCSELs is configured for generating at least one light beam. The VCSEL or the plurality of VCSELs may be configured for generating the desired spot number equal or below or equal 4000 spots, preferably, equal or below 3000 spots, more preferably equal or below 2000 spots. The VCSELs may be configured for emitting light beams at a wavelength range from 800 to 1000 nm. For example, the VCSELs may be configured for emitting light beams at 808 nm, 850 nm, 940 nm, or 980 20 nm. Preferably the VCSELs emit light at 940 nm, since terrestrial sun radiation has a local minimum in irradiance at this wavelength, e.g. as described in CIE 085-1989 “Solar spectral Irradiance”.

The pattern illumination source 114 may comprise at least one optical element, not shown here, configured for increasing, e.g. duplicating, the number of spots, e.g. the spots generated by the pattern projector. The pattern illumination source 114 may comprises at least one diffractive optical element (DOE) and/or at least one metasurface element. The DOE and/or the metasurface element may be configured for generating multiple light beams from a single incoming light beam. For example, a VCSEL projecting up to 2000 spots and an optical element comprising a plurality of metasurface elements may be used to duplicate the number of spots. Other duplications are possible. For example, a VCSEL or a plurality of VCSELs may be used and the generated laser spots may be duplicated by using at least one DOE.

The pattern illumination source 114 may comprise at least one transfer device, not shown here. The transfer device may comprise at least one imaging optical device . The transfer device specifically may comprise one or more of: at least one lens, for example at least one lens selected from the group consisting of at least one focus-tunable lens, at least one aspheric lens, at least one spheric lens, at least one Fresnel lens; at least one diffractive optical element; at least one concave mirror; at least one beam deflection element, preferably at least one mirror; at least one beam splitting element, preferably at least one of a beam splitting cube or a beam splitting mirror; at least one multilens system; at least one holographic optical element; at least one meta optical element. Specifically, the transfer device comprises at least one refractive optical lens stack. Thus, the transfer device may comprise a multi-lens system having refractive properties.

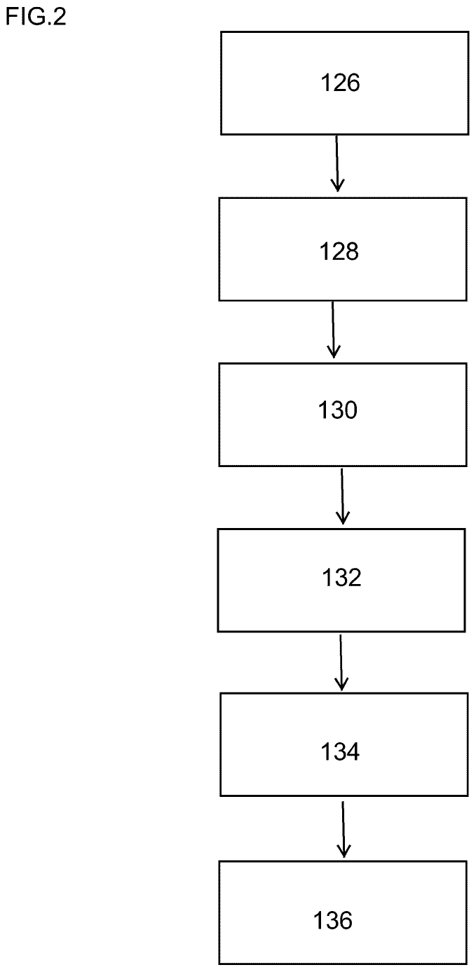

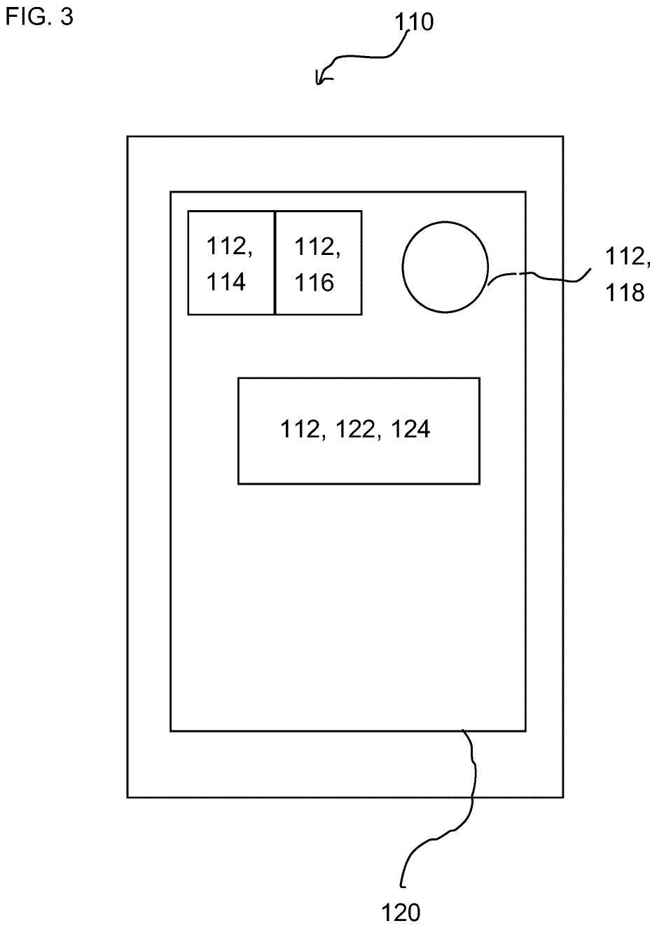

The optoelectronic apparatus 112 comprises the at least one flood illumination source configured for emitting infrared flood light. As may be derived from FIG. 3, a relative distance between the flood illumination source 116 and the pattern illumination source 114 may be below 3.0 mm. The relative distance between the flood illumination source 116 and the pattern illumination source 114 is below 2.5 mm, preferably below 2.0 mm. The pattern illumination source 114 and the flood illumination source 116 may be combined into one module. For example, the pattern illumination source 114 and the flood illumination source 116 may be arranged on the same substrate, in particular having a minimum relative distance. The minimum relative distance may be defined by a physical extension of the flood illumination source 116 and the pattern illumination source 114. Arranging the pattern illumination source 114 and the flood illumination source 116 having a relative distance below 3.0 mm can result in decreased space requirement of the two illumination sources 114, 116. In particular, said illumination sources 114, 116 can even be combined into one module. Such a reduced space requirement can allow reducing the transparent area(s) in a display necessary for operation of the illumination source(s) 114, 116 behind the display 120. The reference number discussed in the context of FIG. 2 may apply correspondingly to FIG. 3.

The optoelectronic apparatus 112 comprises the at least one image generation unit 118 configured for generating at least one pattern image while the pattern illumination source 114 is emitting infrared light pattern and configured for generating at least one flood image while the flood illumination source 116 is emitting infrared flood light.

The image generation unit 118 may be at least one one unit of the optoelectronic apparatus 112 configured for generating at least one image. The image generation may comprise capturing and/or generating and/or determining and/or recording at least one image by using the image generation unit 118. The image generation may comprise imaging and/or recording the image. The image generation may comprise capturing a single image and/or a plurality of images such as a sequence of images. For example, the image generation may comprise recording continuously a sequence of images such as a video or a movie. The image generation may be initiated by a user action or may automatically be initiated, e.g. once the presence of at least one object or user within a field of view and/or within a predetermined sector of the field of view of the image generation unit is automatically detected.

The image generation unit 118 may comprise at least one optical sensor, in particular at least one pixelated optical sensor. The image generation unit 118 may comprise at least one CMOS sensor or at least one CCD chip. For example, the image generation unit 118 may comprise at least one CMOS sensor which may be sensitive in the infrared spectral range. The image may be image data recorded by using the optical sensor, such as a plurality of electronic readings from the CMOS or CCD chip. The image may comprise raw image data or may be a pre-processed image. For example, the pre-processing may comprise applying at least one filter to the raw image data and/or at least one background correction and/or at least one background subtraction.

For example, the image generation unit 118 may comprise a monochrome camera, e.g. comprising monochrome pixels. For example, the image generation unit may comprise a color camera, e.g. comprising color pixels. The image generation unit may comprise a color CMOS camera. For example, the camera may comprise monochrome pixels and color pixels. The color pixels and the monochrome pixels may be combined internally in the camera. The image generation unit 118 may comprise may comprise at least one color camera (e.g. RGB) and/or at least one monochrome camera, such as a monochrome CMOS. The camera may comprise at least one monochrome CMOS chip. The camera generally may comprise a one-dimensional or two-dimensional array of image sensors, such as pixels.

As outlined, above, the image generation unit may be at least one color, e.g. RGB, camera. For example, the color camera may be a selfie camera of a smartphone.

The image generation unit may have a field of view between 10°×10° and 75°×75°, preferably 55°×65°. The image generation unit may have a resolution below 2 MP, preferably between 0.3 MP and 1.5 MP.

The image generation unit may comprise may comprise further elements, such as one or more optical elements, e.g. one or more lenses. As an example, the optical sensor may be a fix-focus camera, having at least one lens which is fixedly adjusted with respect to the camera. Alternatively, however, the camera may also comprise one or more variable lenses which may be adjusted, automatically or manually. Other cameras, however, are feasible.

The pattern image may be an image generated by the image generation unit 118 while illuminating with the infrared light pattern, e.g. on an object and/or a user. The pattern image may comprise an image showing a user, in particular at least parts of the face of the user, while the user is being illuminated with the infrared light pattern. The pattern image may be generated by imaging and/or recording light reflected by an object and/or user which is illuminated by the infrared light pattern. For example, the illumination by the pattern illumination source 114 and the imaging by using the optical sensor may be synchronized, e.g. by using at least one control unit of the optoelectronic apparatus 112.

The flood image may be an image generated by the image generation unit 118 while illumination source is emitting infrared flood light, e.g. on an object and/or a user. The flood image may comprise an image showing a user, in particular the face of the user, while the user is being illuminated with the flood light. The flood image may be generated by imaging and/or recording light reflected by an object and/or user which is illuminated by the flood light. For example, the illumination by the flood illumination source 116 and the imaging by using the optical sensor may be synchronized, e.g. by using at least one control unit of the optoelectronic apparatus 112.

The image generation unit 118 may be configured for imaging and/or recording the pattern image and the flood image at the same time or at different times.

The optoelectronic apparatus 112 may be comprised in the device 110. The device 110 may comprise the at least one display 120, wherein the infrared light pattern traverses the display 120 while being emitted from the pattern illumination source 114 and/or the infrared flood light traverses the display 120 while being emitted from the flood illumination source 116.

Alternatively or in addition, the display 120 may be at least partially transparent in at least one continuous area covering the pattern illumination source 114, the flood illumination source 116 and/or the image generation unit 118.

The display 120 may be an arbitrary shaped device configured for displaying an item of information. The item of information may be arbitrary information such as at least one image, at least one diagram, at least one histogram, at least one graphic, text, numbers, at least one sign, an operating menu, and the like. The display 120 may be or may comprise at least one screen. The display 120 may have an arbitrary shape, e.g. a rectangular shape. The display 120 may be a front display of the device 110.

The display 120 may be or may comprise at least one organic light-emitting diode (OLED) display. The OLED display may be configured for emitting visible light.

The display 120 made of and/or may be covered by glass. In particular, the display 120 may comprise at least one glass cover.

The display 120 may be at least partially transparent. For example, the display 120 may be semitransparent in the near infrared region. For example, the display 120 may have a transparency of 20 % to 50 % in the near infrared region. The display 120 may have a different transparency for other wavelength ranges. The present invention may propose an optoelectronic apparatus 112 comprising the image generation unit 118 and two illumination sources 114, 116 that can be placed behind the display 120 of a device 110. The transparent area(s) of the display 120 can allow for operation of the optoelectronic apparatus 112 behind the display 120. The display 120 can be an at least partially transparent display, as described above. The display 120 may have a reduced pixel density and/or a reduced pixel size and/or may comprise at least one transparent conducting path. The transparent area(s) of the display 120 may have a pixel density of 360-440 PPI (pixels per inch). Other areas of the display 120, e.g. non-transparent areas, may have higher pixels densities, e.g. a pixel density of 460-500 PPI.

The display 120 comprises a display area. The display area may be an active area of the display 120, in particular an area which is activatable. The display 120 may have additional areas such as recesses or cutouts. The display 120 may be at least partially transparent in at least one continuous area, preferably in at least two continuous areas. At least one of the continuous areas may cover the image generation unit and/or the pattern illumination source 114 and/or the flood illumination source 116 at least partially. The pattern illumination source 114, the flood illumination source 116 and the image generation unit 118 may be placed in direction of propagation of the infrared light pattern in front of the display 120.

The display 120 may have a first area associated with a firstpixel density value and a second area associated with a second pixel density value. The first pixel density value may be lower than the second pixel density value. The first pixel density value may be equal to or below 450 PPI, preferably from 300 to 440 PPI, more preferably 350 to 450 PPI. The second pixel density value may be 400 to 500 PPI, preferably 450 to 500 PPI. The first pixel density value is associated with the at least one continuous area being at least partially transparent. The first pixel density value may be below 350 and the second pixel density value may be equal to or more than 400.

As outlined above, known displays fulfilling these requirements are less appealing to users and the transparent area is desired to be decreased. Moreover, usually, covering the image generation unit with such a display can result in a low contrast because of the light transmission of 15% to 50 % in transparent regions. The contrast may be defined as a difference between signal and backlight. In this case, the contrast can be considered to be reduced by the transmission. However, the contrast may be defined as a ratio of signal to background. In this case, the contrast may not be reduced by the transmission only, but by the diffraction in the spot pattern projection as the higher orders bring additional intensity besides the zero-th order. Diffraction may further take place due to the structure of a display wiring leading to a further decrease in irradiance. Moreover, the spot pattern projected through a display can result in main spots corresponding to the pattern before traversing the display area with reduced intensity because higher order spots are generated. Both effects lead to a reduction in irradiance to about 3-5% of initial irradiance and the presence of undesired additional spots in the pattern. The present invention allows for providing a sufficient irradiance and, thus, contrast in the pattern image. The contrast can be increased by decreasing the number of spots projected onto the user. This can lead to an increase in irradiance of a spot and thus, to an increase in contrast in an image of the projection of the spot pattern. Moreover, reducing of transparent areas in displays can be possible. Using such an optoelectronic apparatus 112 can allow for a rearrangement of the position of a camera, e.g. from the outer most position of the display. Such a rearrangement can allow for an optimized wiring since a further position, the position of the image generation unit 118, can be optimized. This can decrease the used wiring or allow for an improved battery operation.

The device 110 is configured for authenticating a user of a device 110 to perform at least one operation on the device 110 that requires authentication. The authenticating may comprise verifying an identity of a user. Specifically, the authentication may comprise distinguishing between the user from other humans or objects, in particular between authorized access from non-authorized accesses. The authentication may comprise verifying identity of a respective user and/or assigning identity to a user. The authentication may comprise generating and/or providing identity information, e.g. to other devices or units such as to at least one authorization unit for authorization for providing access to the device 110. The identify information may be proofed by the authentication. For example, the identity information may be and/or may comprise at least one identity token. In case of successful authentication an image of a face recorded by the image generation unit 118 may be verified to be an image of the user's face and/or the identity of the user is verified.

The authenticating of the user may be performed using at least one authentication unit 122. The authentication unit 122 may be configured for performing at least one authentication process of a user. The authentication unit 122 may comprise at least one processor. The processor may be an arbitrary logic circuitry configured for performing basic operations of a computer or system, and/or, generally, to a device which is configured for performing calculations or logic operations. In particular, the processor may be configured for processing basic instructions that drive the computer or system. As an example, the processor may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. In particular, the processor may be a multi-core processor. Specifically, the processor may be or may comprise a central processing unit (CPU). Additionally or alternatively, the processor may be or may comprise a microprocessor, thus specifically the processor's elements may be contained in one single integrated circuitry (IC) chip. Additionally or alternatively, the processor may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The processor specifically may be configured, such as by software programming, for performing one or more evaluation operations.

The authentication unit 122 is configured for identifying the user based on the flood image. The identifying may comprise assigning an identity to a detected face and/or at least one identity check and/or verifying an identity of the user. The authentication process may comprise a plurality of steps. For example, the authentication process may comprise performing at least one face detection. The face detection step may comprise analyzing the flood image. In addition, for example, the authentication process may comprise identifying. The identifying may comprise assigning an identity to a detected face and/or at least one identity check and/or verifying an identity of the user. The identifying may comprise analyzing the flood image. The analyzing of the flood image may comprise performing a face verification of the imaged face to be the user's face. The identifying the user may comprise matching the flood image, e.g. showing a contour of parts of the user, in particular parts of the user's face, with a template. The identifying of the user may comprise determining if the imaged face is the face of the user, in particular if the imaged face corresponds to at least one image of the user's face stored in at least one memory, e.g. of the device.

The analyzing of the flood image may comprise one or more of the following: a filtering; a selection of at least one region of interest; a formation of a difference image between the flood image and at least one offset; an inversion of flood image; a background correction; a decomposition into color channels; a decomposition into hue; saturation; and brightness channels; a frequency decomposition; a singular value decomposition; applying a Canny edge detector; applying a Laplacian of Gaussian filter; applying a Difference of Gaussian filter; applying a Sobel operator; applying a Laplace operator; applying a Scharr operator; applying a Prewitt operator; applying a Roberts operator; applying a Kirsch operator; applying a high-pass filter; applying a low-pass filter; applying a Fourier transformation; applying a Radon-transformation; applying a Hough-transformation; applying a wavelet-transformation; a thresholding; creating a binary image. The region of interest may be determined manually by a user or may be determined automatically, such as by recognizing the user within the image. In particular, the analyzing of the flood image may comprise using at least one image recognition technique, in particular a face recognition technique. An image recognition technique comprises at least one process of identifying the user in an image. The image recognition may comprise using at least one technique selected from the technique consisting of: color-based image recognition, e.g. using features such as template matching; image segmentation and/or blob analysis e.g. using size, or shape; machine learning and/or deep learning e.g. using at least one convolutional neural network.

The analyzing of the flood image may comprise determining a plurality of facial features. The analyzing may comprise comparing, in particular matching, the determined facial features with template features. The template features may be features extracted from at least one template. The template may be or may comprise at least one image generated in an enrollment process, e.g. when initializing the device 110. Template may be an image of an authorized user. The template features and/or the facial feature may comprise a vector. Matching of the features may comprise determining a distance between the vectors. The identifying of the user may comprise comparing the distance of the vectors to a least one predefined limit, wherein the user is successfully identified in case the distance is ≤the predefined limit at least within tolerances. The user declining and/or rejected otherwise.

For example, the image recognition may comprise using at least one model, in particular a trained model comprising at least one face recognition model. The analyzing of the flood image may be performed by using a face recognition system, such as FaceNet, e.g. as described in Florian Schroff, Dmitry Kalenichenko, James Philbin, “FaceNet: A Unified Embedding for Face Recognition and Clustering”, arXiv: 1503.03832. The trained model may comprises at least one convolutional neural network. For example, the convolutional neural network may be designed as described in M. D. Zeiler and R. Fergus, “Visualizing and understanding convolutional networks”, CoRR, abs/1311.2901, 2013, or C. Szegedy et al., “Going deeper with convolutions”, CoRR, abs/1409.4842, 2014. For more details with respect to convolutional neural network for the face recognition system reference is made to Florian Schroff, Dmitry Kalenichenko, James Philbin, “FaceNet: A Unified Embedding for Face Recognition and Clustering”, arXiv: 1503.03832. As training data labelled image data from an image database may be used. Specifically, labeled faces may be used from one or more of G. B. Huang, M. Ramesh, T. Berg, and E. Learned-Miller, “Labeled faces in the wild: A database for studying face recognition in unconstrained environments”, Technical Report 07-49, University of Massachusetts, Amherst, October 2007, the Youtube® Faces Database as described in L. Wolf, T. Hassner, and I. Maoz, “Face recognition in unconstrained videos with matched background similarity”, in IEEE Conf. on CVPR, 2011, or Google® Facial Expression Comparison dataset. The training of the convolutional neural network may be performed as described in Florian Schroff, Dmitry Kalenichenko, James Philbin, “FaceNet: A Unified Embedding for Face Recognition and Clustering”, arXiv: 1503.03832.

The authentication unit 122 is configured for using a facial recognition authentication process operating on the pattern image, the flood image and/or extracted material data. The authentication unit 122 may be configured for extracting material data from the pattern image.

The authentication unit 122 may be configured for extracting the material data from the pattern image by beam profile analysis of the light spots. With respect to beam profile analysis reference is made to WO 2018/091649 A1, WO 2018/091638 A1 and WO 2018/091640 A1, the full content of which is included by reference. Beam profile analysis can allow for providing a reliable classification of scenes based on a few light spots. Each of the light spots of the pattern image may comprise a beam profile. The extracting of the material data based on the pattern image may be performed by using at least one model.

The authentication process may comprise validating based on the extracted material data. The validating based on the extracted material data may comprise determining if the extracted material data corresponds a desired material data. Determining if extracted material data matches the desired material data may be referred to as validating. Allowing or declining the user and/or object to perform at least one operation on the device 110 that requires authentication based on the material data may comprise validating the authentication or authentication process. Validating may be based on material data and/or image. Determining if the extracted material data corresponds a desired material data may comprise determining a similarity of the extracted material data and the desired material data. Determining a similarity of the extracted material data and the desired material data may comprise comparing the extracted material data with the desired material data. Desired material data may refer to predetermined material data. In an example, desired material data may be skin. It may be determined if material data may correspond to the desired material data. In the example, material data may be non-skin material or silicon. Determining if material data corresponds to a desired material data may comprise comparing material data with desired material data. A comparison of material data with desired material data may result in a allowing and/or declining the user and/or object to perform at least one operation that requires authentication. In the example, skin as desired material data may be compared with non-skin material or silicon as material data and the result may be declination since silicon or non-skin material may be different from skin. In an embodiment, the authentication process or its validation may include generating at least one feature vector from the material data and matching the material feature vector with associate reference template vector for material.

The authentication unit 122 may be configured for authenticating the user in case the user can be identified and/or if the material data matches the desired material data. The device 110 may comprise at least one authorization unit 124 configured for allowing the user to perform at least one operation on the device 110, e.g. unlocking the device 110, in case of successful authentication of the user or declining the user to perform at least one operation on the device 110 in case of non-successful authentication.

FIG. 2 shows an exemplary embodiment of a method for authenticating a user of a device 110 to perform at least one operation on the device 110 that requires authentication. the method comprising:
a. (reference number 126) illuminating the user with at least one infrared light pattern from at least one pattern illumination source 114 of the device 110, particularly wherein the number of infrared light spots is below or equal 4000 spots;
b. (reference number 128) illuminating the user with infrared flood light from at least one flood illumination source 116 of the device 110,
c. (reference number 130) generating at least one pattern image with an image generation unit 118 of the device 110 showing the user, in particular at least parts of the face of the user, while the user is being illuminated with the infrared light pattern, and generating at least one image with an image generation unit 118 of the device showing the user while the user is being illuminated with the infrared flood light, wherein the display 120 of the device 110 is at least partially transparent in at least one continuous area covering the pattern illumination source 114, the flood illumination source 116 and/or the image generation unit 118,
d. (reference number 132) identifying the user based on the flood image by using at least one authentication unit 122 of the device 110,
e. (reference number 134) extracting material data from the at least one pattern image by using the authentication unit 122; and
f. (reference number 136) allowing the user to perform at least one operation on the device 110 that requires authentication based on the material data and the identifying.

The method steps may be performed in the given order or may be performed in a different order. Further, one or more additional method steps may be present which are not listed. Further, one, more than one or even all of the method steps may be performed repeatedly. The pattern image and/or the image showing the user while the user is being illuminated with the infrared flood light may be showing at least a portion of a face of the user.

The method may be computer implemented.

### LIST OF REFERENCE NUMBERS

110 device
112 optoelectronic apparatus
114 pattern illumination source
116 flood illumination source
118 image generation unit
120 display
122 authentication unit
124 authorization unit
126 illuminating the user with infrared light pattern
128 illuminating the user with infrared flood light
130 generating at least one pattern image and generating at least one flood image
132 identifying the user
134 extracting material data
136 allowing

1. An optoelectronic apparatus comprising:
at least one pattern illumination source configured for emitting at least one infrared light pattern comprising a plurality of infrared light spots, wherein the number of infrared light spots is below or equal 4000 spots,
at least one flood illumination source configured for emitting infrared flood light, and
at least one image generation unit configured for generating at least one pattern image while the pattern illumination source is emitting the infrared light pattern and configured for generating at least one flood image while the flood illumination source is emitting infrared flood light.

2. The optoelectronic apparatus according to claim 1, wherein the optoelectronic apparatus is comprised in a device, wherein the device comprises at least one display, wherein the infrared light pattern traverses the display while being emitted from the pattern illumination source and/or the infrared flood light traverses the display while being emitted from the flood illumination source, and wherein the display is at least partially transparent in at least one continuous area covering the pattern illumination source, the flood illumination source and/or the image generation unit.

3. The optoelectronic apparatus according to claim 1, wherein the infrared light pattern comprises equal to or less than 3000 spots.

4. The optoelectronic apparatus according to claim 1, wherein the infrared light is coherent.

5. The optoelectronic apparatus according to claim 1, wherein the infrared light pattern is a hexagonal pattern.

6. The optoelectronic apparatus according to claim 1, wherein at least one of the infrared light spots is associated with a beam divergence of 0.2° to 0.5°.

7. The optoelectronic apparatus according to claim 1, wherein the image generation unit has a field of view between 10°×10° and 75°×75°.

8. The optoelectronic apparatus according to claim 1, wherein the pattern illumination source comprises at least one vertical cavity surface-emitting laser (VCSEL), and/or wherein the pattern illumination source comprises at least one optical element configured for increasing the number of spots, and wherein the at least one optical element comprises at least one diffractive optical element and/or at least one metasurface element.

9. A method of using an optoelectronic apparatus according to claim 1, the method comprising using the optoelectronic apparatus for authenticating a user of a device comprising the optoelectronic apparatus.

10. A device for authenticating a user of the device to perform at least one operation on the device that requires authentication, the device comprising:
at least one flood illumination source configured for emitting infrared flood light;
at least one pattern illumination source configured for emitting at least one infrared light pattern comprising a plurality of infrared light spots, wherein the number of infrared light spots is below 4000 spots;
at least one image generation unit configured for generating at least one pattern image while the pattern illumination source is emitting the infrared light pattern and configured for generating at least one flood image while the flood illumination source is emitting infrared flood light;
at least one display, wherein the infrared light pattern traverses the display while being illuminated from the pattern illumination source and/or the infrared flood light traverses the display while being illuminated from the flood illumination source, wherein the display of the device is at least partially transparent in at least one continuous area covering the pattern illumination source, the flood illumination source and/or the image generation unit, and
at least one authentication unit configured for performing at least one authentication process of a user using the flood image and the pattern image.

11. The device according to claim 10, wherein the display has a first area associated with a first pixel per inch (PPI) value and a second area associated with a second PPI value, wherein the first PPI value is lower than the second PPI value.

12. The device according to claim 11, wherein
the first PPI value is less than 350; and
the second PPI value is equal to or more than 400.

13. A method for authenticating a user of a device to perform at least one operation on the device (110) that requires authentication, the device comprising a display and the method comprising:
a. illuminating the user with at least one infrared light pattern from at least one pattern illumination source of the device;
b. illuminating the user with infrared flood light from at least one flood illumination source of the device;
c. generating at least one pattern image with an image generation unit of the device showing the user while the user is being illuminated with the infrared light pattern, and generating at least one image with an image generation unit of the device showing the user while the user is being illuminated with the infrared flood light, wherein the display of the device is at least partially transparent in at least one continuous area covering the pattern illumination source, the flood illumination source and/or the image generation unit;
d. identifying the user based on the flood image by using at least one authentication unit of the device;
e. extracting material data from the at least one pattern image by using the authentication unit; and
f. allowing the user to perform at least one operation on the device that requires authentication based on the material data and the identifying.

14. A computer program comprising instructions, wherein when the program is executed by the device according to claim 10, the instructions cause the device to perform a method comprising:
a. illuminating the user with at least one infrared light pattern from at least one pattern illumination source of the device;
b. illuminating the user with infrared flood light from at least one flood illumination source of the device;
c. generating at least one pattern image with an image generation unit of the device showing the user while the user is being illuminated with the infrared light pattern, and generating at least one image with an image generation unit of the device showing the user while the user is being illuminated with the infrared flood light, wherein the display of the device is at least partially transparent in at least one continuous area covering the pattern illumination source, the flood illumination source and/or the image generation unit;
d. identifying the user based on the flood image by using at least one authentication unit of the device;
e. extracting material data from the at least one pattern image by using the authentication unit; and
f. allowing the user to perform at least one operation on the device that requires authentication based on the material data and the identifying.

15. A computer-readable storage medium comprising instructions, wherein when the instructions are executed by the device according to claim 10, the instructions cause the device to perform a method comprising:
a. illuminating the user with at least one infrared light pattern from at least one pattern illumination source of the device;
b. illuminating the user with infrared flood light from at least one flood illumination source of the device;
c. generating at least one pattern image with an image generation unit of the device showing the user while the user is being illuminated with the infrared light pattern, and generating at least one image with an image generation unit of the device showing the user while the user is being illuminated with the infrared flood light, wherein the display of the device is at least partially transparent in at least one continuous area covering the pattern illumination source, the flood illumination source and/or the image generation unit;
d. identifying the user based on the flood image by using at least one authentication unit of the device;
e. extracting material data from the at least one pattern image by using the authentication unit; and
f. allowing the user to perform at least one operation on the device that requires authentication based on the material data and the identifying.

16. A non-transient computer-readable medium comprising instructions, wherein when executed by one or more processors, the instructions cause the one or more processors to perform the method according to claim 13.

17. The optoelectronic apparatus according to claim 1, wherein the infrared light pattern comprises equal to or less than 2000 spots.

18. The optoelectronic apparatus according to claim 1, wherein at least one of the infrared light spots is associated with a beam divergence of 0.1° to 0.3°.

19. The optoelectronic apparatus according to claim 1, wherein the pattern illumination source comprises a plurality of vertical cavity surface-emitting laser (VCSEL), and/or wherein the pattern illumination source comprises at least one optical element configured for increasing the number of spots, wherein the at least one optical element comprises at least one diffractive optical element and/or at least one metasurface element.
